(19) United States
(12) Patent Application Publication
(10) Pub. No.: US 2014/0362485 A1
(43) Pub. Date: Dec. 11, 2014

(54) Transient Protection Filter Circuit that Minimizes the Effects of Thermal Runaway

(71) Applicant: William Smith, Lindenhurst, NY (US)

(72) Inventor: William Smith, Lindenhurst, NY (US)

(21) Appl. No.: 13/911,305

(22) Filed: Jun. 6, 2013

(51) Int. Cl. H02H 9/04

(52) U.S. Cl. CPC H02H 9/04
USPC 361/86

(57) ABSTRACT

Commonly, a transient protection filter circuit is integrated between power sources and the circuits that follow to suppress voltage transients. Pre-existing transient protection filters are implemented such that when a transient is detected, transistors in the path become linear regulators. Instead, this invention uses bridge resistors to form a voltage divider to dissipate the extra power. The novelty of this invention is that it protects the load not by dissipating the extra power in front of the load as other transient protection filter circuits do, but by providing energy from the transient to the load through a resistor. This implementation solves the problem of thermal runaway that is commonly caused when transient voltages are filtered by dissipating power within the transistors in the path of the transient and the electric circuits after the transistors.

### FIELD OF THE INVENTION

The present invention is directed to improvements in electrical circuits and in particular the use of transient or surge filters for preventing damage to circuits from voltage transient surges

### BACKGROUND OF THE INVENTION

Commonly, high voltage transients are inadvertently coupled into power lines that source electrical devices. In particular, DC powered electrical systems are subject to harmful and unwanted voltage transients or surges that can advertently be coupled to the equipment's power lines. The transients can cause damage to the electrical circuits therein. Commonly, the electrical system requiring DC power contains a voltage transient protection filter that is placed between the DC power input lines and the circuits that follow to suppress the voltage transients to a safe voltage level when the energy reaches the load.

In the art, the terms “transient” and “surge” are used interchangeably to describe temporary rises in voltage and current in an electrical circuit that are in excess of the normal operational values. The description of this invention and the claims applied therein has settled upon using the term “transient” as the means of identification for the occurrence of a rise in voltage; except, when in describing how the invention is used for a particular application, such as its use to support a military standard, the term “surge” is applied in the standard as its definition for the voltage rise. Nonetheless, it is expected that the disclosure of this invention covers all implementations of “surge filters” and/or “transient filters” and various combinations of the terms thereof.

A typical application of a transient protection filter is in military equipment. Such equipment may operate in an aircraft, ground vehicles, and other militarized gear and weaponry. Two common voltage transients or surges are referred respectively as the “50 Volt test” in MIL-STD-704 or the “100 Volt test” in MIL-STD-1275.

Industry transient filters consist of a power MOSFET (field effect transistor, or FET), with a very low drain-source resistance connected between the DC input and the circuits that follow, or load. Additionally, the filters have a sensing circuit across the DC input that detects voltages higher than the normal operational value. The higher voltages are called transients or surges. In normal operation, the FET is switched on to pass the DC power from the input, through the FET, to the load. The FET's low drain to source resistance, hence low voltage drop, insures low power dissipation at the FET's junction in spite of passing high current to the load.

When the sensing circuit detects a transient on the input power lines, the FET is immediately configured as a series-pass linear regulator. Effectively, the FET becomes a resistor which reduces the transient to a safe level at the load. When the FET is acting as a linear regulator, the voltage difference between the input and the load appear entirely across the FET thus that voltage, when multiplied by the current flowing through the FET, determines the power dissipation in the FET. That power is usually considerable, even in low powered equipment. For example, if the equipment normally operates at 24 volts and draws 10 amps, a 100 volt transient will cause 76 volts to appear across the FET. The current remains at 10 amps. The result is that while the transient is present, the FET is dissipating 760 watts during the entire time that the transient is present. This is problematic because the more power dissipation, the more heating of the FET's junction, which further increases the junction temperature and can cause a condition known as thermal runaway. Thermal runaway refers to a situation where an increase in temperature changes the conditions in a way such that there is a further increase in temperature, often leading to a destructive result such as the destruction of the FET. Effectively, if the heat sink cannot transfer the heat from the FET's junction fast enough, the FET will be destroyed, rendering the transient filter useless. Some implementations of a transient filter add a thermostat or some equivalent temperature detecting device to shut the FET off to try and prevent the FET's destruction.

Throughout the industry, manufacturers of voltage transient filters use the implementation that has been described herein, with variations in the sensing circuitry and the time limiting and thermal cutoff circuitry. The type and number of FETs connected in parallel may also vary, but each manufacturer configures the FET as a linear regulator and the thermal runaway problem is still a major concern for all of the available industry solutions. Hence, there is a need to minimize the threat of a thermal runaway condition which can destroy the FET, since FET junctions are too timid for handling such high peak power which is present during a voltage transient. The present invention is an improved voltage transient filter that eliminates the FET's participation in dividing the transient's high voltage down to the safe output level accomplishing the objective of removing the threat of damage due to thermal runaway. The present invention electronically diverts the transient's energy, constructively into an arrangement of resistors that in combination with switching mechanisms form a voltage divider that uses the transient's energy to provide a safe voltage level before it gets to the electrical circuits. The present invention protects the load not by dissipating the extra power in front of the load as other transient protection filter circuits do, but by providing energy from the transient to the load through a resistor. Additionally, the present invention enables greater flexibility and cost effectiveness for the choice of components chosen for the switching device of the voltage transient filter; such components may include transistors, FETS and relays.

### OBJECTS OF THE INVENTION

Accordingly, an object of the present invention is to provide an improved transient protection circuit.

Another object of the present invention is to provide an improved transient protection circuit to prevent thermal runaway from destroying the circuitry.

Another object of the present invention is to provide an improved transient protection circuit which provides more flexibility and scalability than what is currently available in the industry.

Another object of the present invention is to provide an improved transient protection circuit that is more resilient than what is currently available in the industry.

A further object of the invention is to provide a smaller circuit board as the FETs that are used to absorb the transient are smaller than the corresponding resistors.

A still another object of the invention is to provide an improved circuit using FETs because of their size makes it much easier to dissipate heat on a PWB (printed wiring board) or an through the use of an external heat sink.

A still further object of the invention is to provide a circuit that results in a less costly electrical and mechanical design for a device using the circuit.

### BRIEF DESCRIPTION OF THE DRAWINGS

FIG. 1 is a simplified block and behavioral state diagram of the invention's preferred embodiment.

FIG. 2 is a detailed schematic of a preferred embodiment of the invention.

FIG. 2a is a detailed schematic of another embodiment of the invention.

FIG. 3 is a board layout for the preferred embodiment

FIG. 4 contains images of the components under testing scenarios in the preferred embodiment.

### DETAILED DESCRIPTION OF THE PRIOR ART

A typical pre-existing surge protection circuit uses a FET placed in series with a DC source and a load. Functioning as a switching device, the FET's gate is driven based upon some kind of feedback or comparison of some pre-determined voltage threshold. When the voltage exceeds the threshold, the FET is configured as a linear regulator such that the voltage difference between the DC source and the load appears entirely across the FET.

Therefore, while the load is operational, the overvoltage is dropped across the FET. If the voltage transient is abnormally high or lasts unusually long, the potential of damage to the FET and existing circuitry increases greatly. Some of the prior art implements an adjustable overvoltage timer for preventing FET damage during the transient or surge, while an additional second timer provides for a FET cool down. In this instance, the prior art will produce a fault to shutdown the circuit and limit the quiescent current in an attempt to abort a thermal runaway occurrence. The current invention will minimize the problems that occur because the prior art is carrying the transient voltage entirely over the FET.

Applicant hereby incorporates by reference herein the subject matter and teachings of the following: MIL-STD-704 and MIL-STD-1275 inclusive of all revisions to date.

### DESCRIPTION OF A PREFERRED EMBODIMENT

The present invention eliminates the FET's participation in dividing the transient's high voltage down to a safe output level. The effect of no longer requiring voltage to be run across a switching device during a transient enables the invention to function using different variations of switching devices including transistors, FETs, and relays. A preferred embodiment of the invention still uses a series FET and a transient sensing circuit during normal operation. However when a transient is detected, instead of using the FET as a resistor to drop the power exposing the FET to thermal runaway, the FET is switched open so that no current can flow through it. Upon the sensing of a transient (increased voltage), the sensing circuit will remove the gate source drive turning the FET off. The FET is bridged with a resistor such that the resistor now forms a voltage divider between the transient's higher voltage and the voltage required by the load. Thus, the resistor dissipates the extra power from the transient, not the FET. The benefit is that the FET operates either “ON” (in normal operation) or “OFF” and the result is the FET would not be subject to destruction. A preferred embodiment must be able to quickly meet changes in the transient's width and amplitude. This is accomplished by using a combination of pulse width modification (PWM) on the input FET and an additional resistor across the load but in series with a second FET that is also pulse width modulated.

Notably, in a preferred embodiment, the FET is used “digitally” either in the saturated or ‘OFF” state. A preferred embodiment eliminates prolonged linear operation hence the inherent large power dissipation no longer is present in the FET.

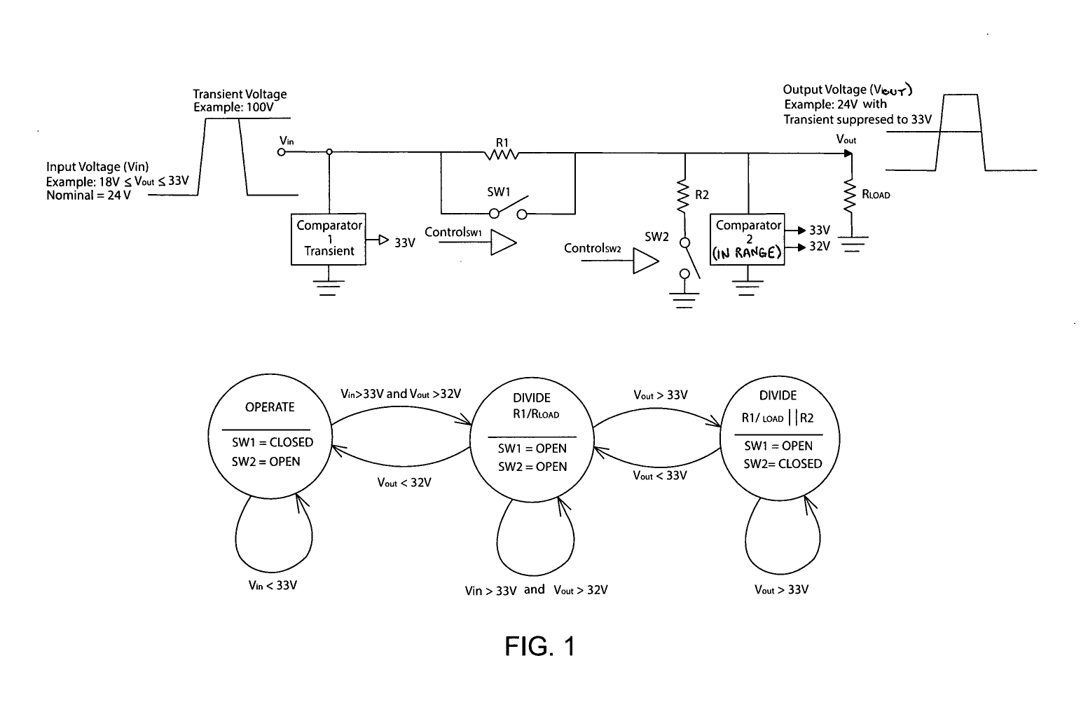

FIG. 1's block diagram and behavioral state diagram illustrates how a preferred embodiment automatically adjusts to output dynamic load variations and transient voltage and width variations. A preferred embodiment contains a self-resetting thermostat (not shown) to protect against prolonged transients. A prolonged transient may cause the resistors to overheat but at no time are the FETs subject to overheating. The present invention allows for a choice of switching devices (PETS, transistors or relays) and resistor values to make the implementation scalable. The present invention also allows for a choice of voltage thresholds that make the implementation scalable with respect to surge amplitude(s) and normal operational values at the load.

The present invention also allows for a choice of voltage thresholds and hysteresis thresholds that make the implementation scalable with respect to ripple requirements.

The present invention also allows for a choice of voltage thresholds that make the implementation scalable with respect to output voltage.

In a preferred embodiment there are three valid states for the two FETs referred to as SW1 and SW2 in FIG. 1. The fourth state, SW1 and SW2 both on, is a “halt” state and it is prohibited by the control logic to SW1 and SW2, CONTROLsw1 and CONTROLsw2.

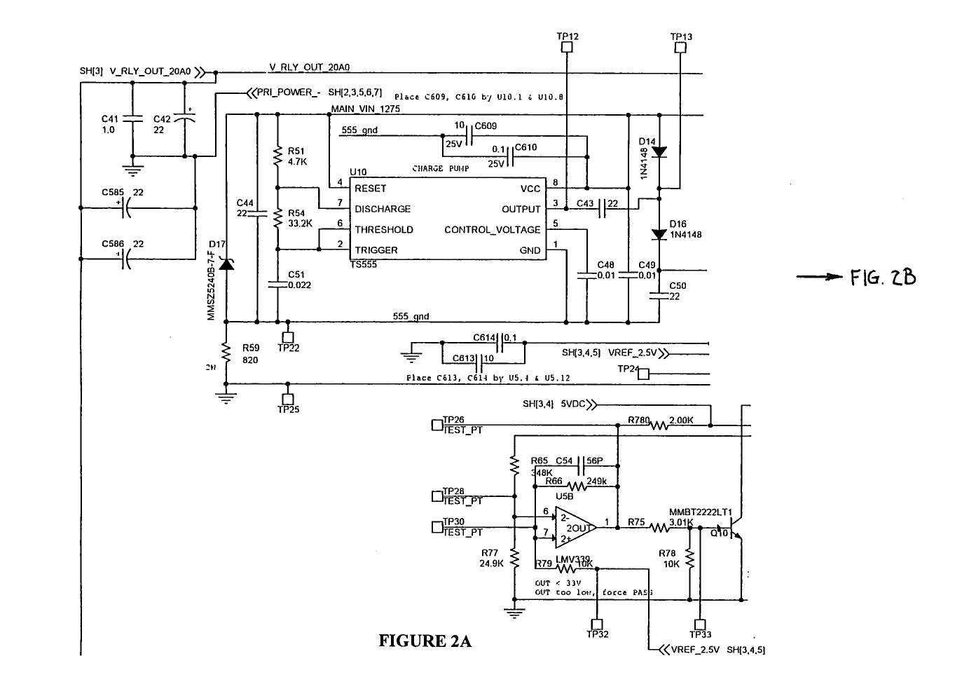

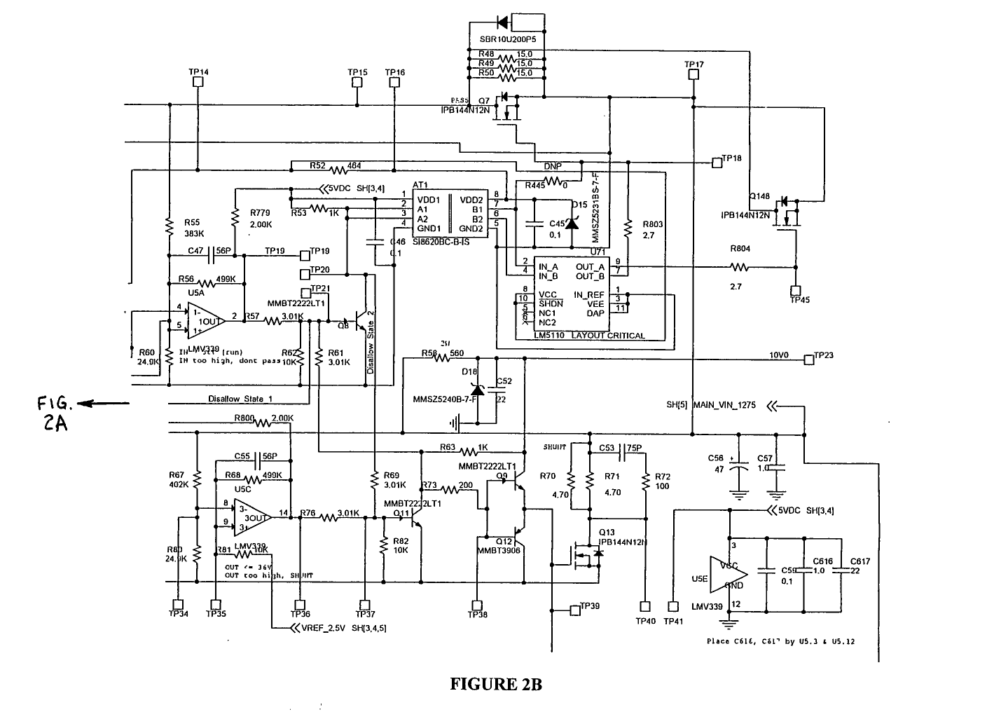

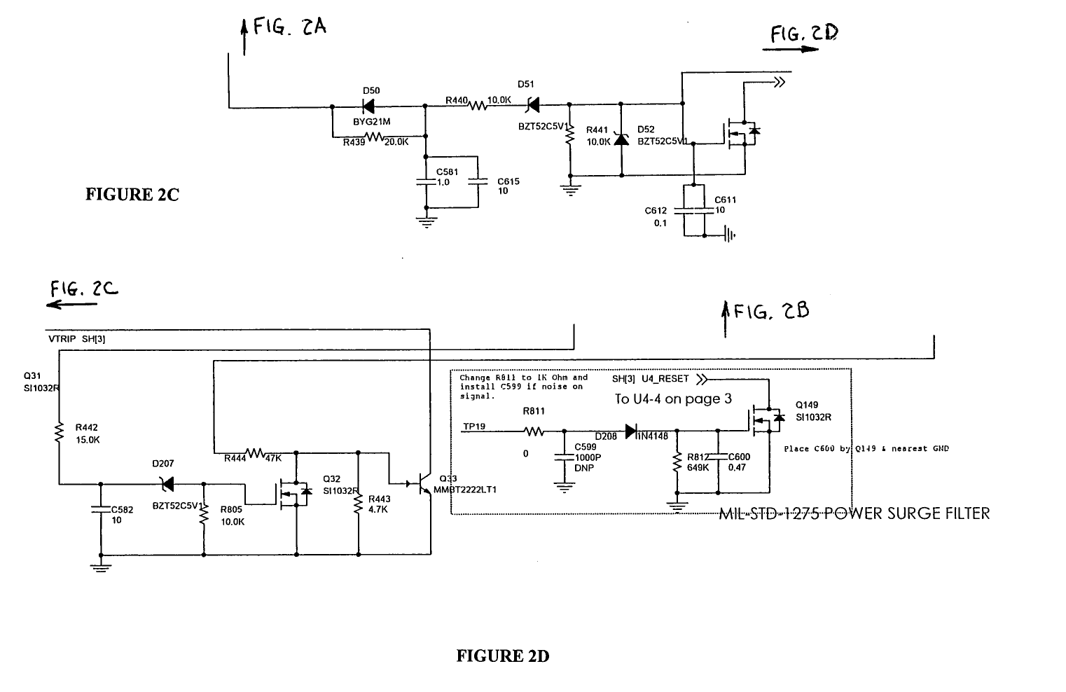

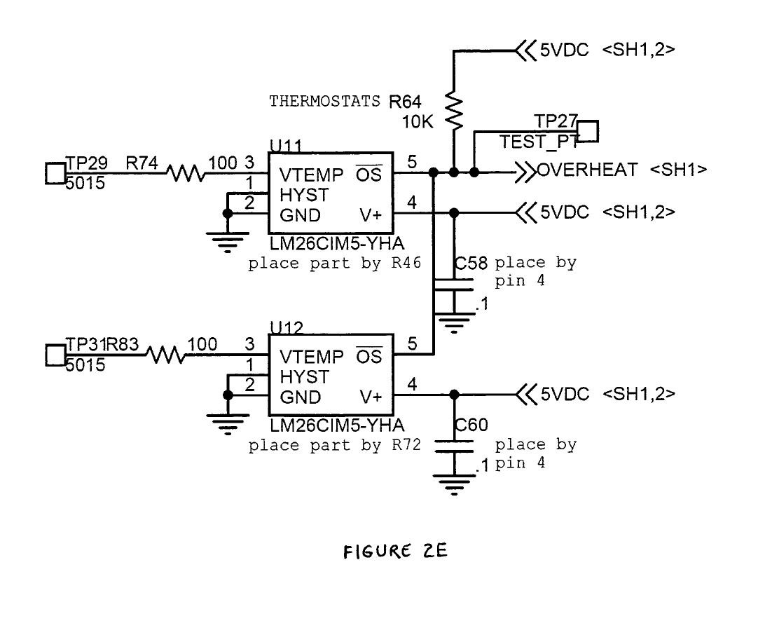

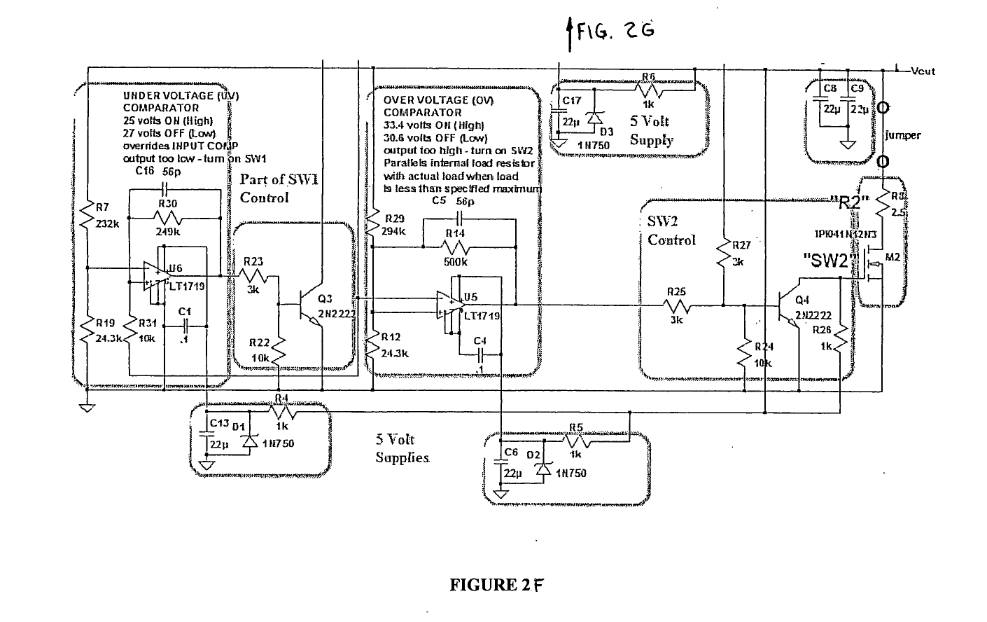

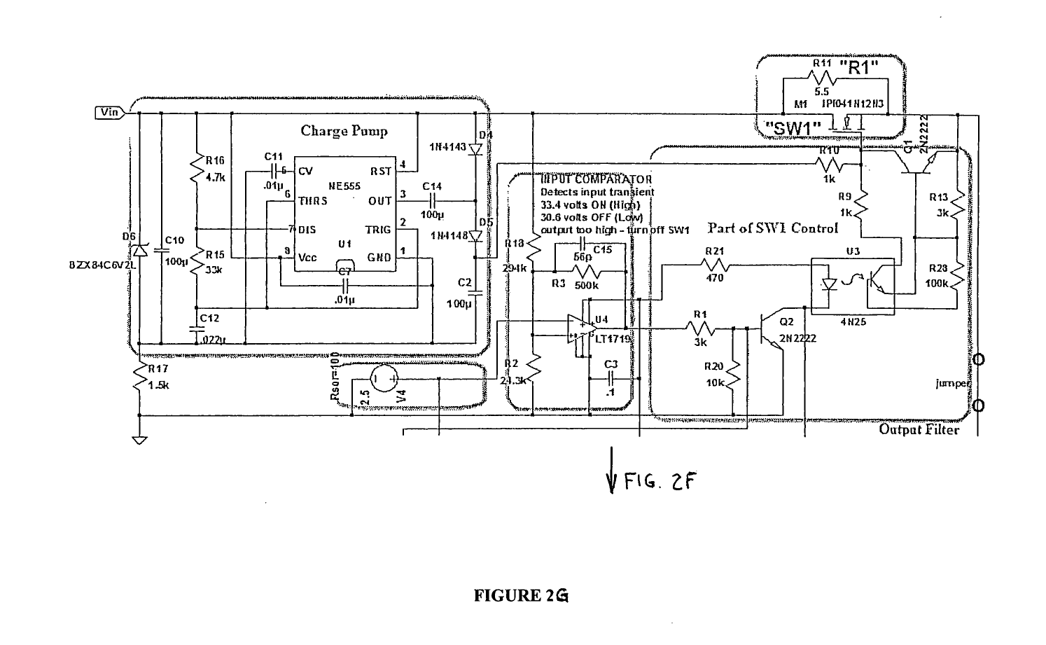

The speed of the transitions from state to state is determined by the circuitry used to drive the FETs. The mixed analog/digital implementation examples provided in FIG. 2 represent asynchronous transitioning determined by the closed loop signals from comparators with hysteresis. The Hardware Description Language (HDL) example which uses a microcomputer and is described in Table 1 could also be clocked to provide synchronous control. In either case both the thresholds of the comparators and the hysteresis determine the output voltage ripple. The rise and fall times of the FETs and their drive circuits are very fast compared to the dwell times in each state, therefore the amount of time that the FETs are linear is insignificant. Dwelling in each state is long enough to allow time for the FETs to reach either their saturated or cutoff condition as well as much longer than their rise/fall times, hence there is no significant ripple at the output.

```
TABLE 1
entity MIL1275 is
    port (INGT33: in STD_LOGIC;OUTGT33: in
    STD_LOGIC;OUTLT32: in STD_LOGIC);
end MIL1275;
architecture MIL_1275_ARCH of MIL1275 is
-- diagram signals declarations
signal SW1: STD_LOGIC;
signal SW2: STD_LOGIC;
-- ONE HOT ENCODED state machine: SM1275
attribute enum_encoding: string;
type SM1275_type is ( R1_DIV_R2_RL, R1_DIV_RL, OPERATE,
NOT_ALLOWED);
attribute enum_encoding of SM1275_type: type is
“0001 0010 0100 1000” ;
signal SM1275, NextState_SM1275: SM1275_type;
begin
-- Machine: SM1275
-- Next State Logic (combinatorial)
SM1275_NextState: process (INGT33, OUTGT33, OUTLT32, SM1275)
Begin
    NextState_SM1275 <= OPERATE;
    -- Set default values for outputs and signals
    SW1 <= ‘1’;
    SW2 <= ‘0’;
    if SM1275 = R1_DIV_R2 RL then
        SW1<=‘0’;
        SW2<=‘1’;
        if OUTLT32=‘1’ then
            NextState_SM1275 <= R1_DIV_RL;
            SW1<=‘0’;
            SW2<=‘0’;
        elsif OUTGT33=‘1’ then
            NextState_SM1275 <= R1_DIV_R2_RL;
            SW1<=‘0’;
            SW2<=‘1’;
        else
            NextState_SM1275 <= OPERATE;
            SW1<=‘1’;
            SW2<=‘0’;
        end if;
    elsif SM1275 = R1_DIV_RL then
        SW1<=‘0’;
        SW2<=‘0’;
        if OUTLT32=‘1’ then
            NextState_SM1275 <= OPERATE;
            SW1<=‘1’;
            SW2<=‘0’;
        elsif OUTGT33=‘1’ then
            NextState_SM1275 <= R1_DIV_R2_RL;
            SW1<=‘0’;
            SW2<=‘1’;
        elsif INGT33=‘1’ AND OUTLT32=‘0’ then
            NextState_SM1275 <= R1_DIV_RL;
            SW1<=‘0’;
            SW2<=‘0’;
        else
            NextState_SM1275 <= OPERATE;
            SW1<=‘1’;
            SW2<=‘0’;
        end if;
    elsif SM1275 = OPERATE then
        if INGT33=‘1’ AND OUTLT32=‘0’ then
            NextState_SM1275 <= R1_DIV_RL;
            SW1<=‘0’;
            SW2<=‘0’;
        elsif INGT33=‘0’ then
            NextState_SM1275 <= OPERATE;
            SW1<=‘1’;
            SW2<=‘0’;
        else
            NextState_SM1275 <= OPERATE;
            SW1<=‘1’;
            SW2<=‘0’;
        end if;
    elsif SM1275 = NOT_ALLOWED then
        SW1<=‘0’;
        SW2<=‘0’;
        NextState_SM1275 <= OPERATE;
        SW1<=‘1’;
        SW2<=‘0’;
    else
        -- trap state
        NextState_SM1275 <= NOT_ALLOWED;
    end if;
end process;
-- Current State Logic
SM1275_CurrentState: process (NextState_SM1275)
begin
    SM1275 <= NextState_SM1275 after 1 ns;
end process;
end MIL_1275_ARCH;
```

The NORMAL state, shown with SW1 closed and SW2 open, simply passes whatever voltage is on the input to the output. It will remain in the NORMAL state as long as the input voltage is below the maximum allowable input voltage. The following scenario and the diagrams provided as FIGS. 1-2 uses the example maximum voltage of 33 volts (the threshold voltages can be varied based on resistor values).

An examination of FIG. 1 and the following narrative provide a functional description of a preferred embodiment. If COMPARATOR1 detects a voltage greater than 33 volts, a transition to the DIVIDE R1/RLOAD state will occur. SW1 will open and all current will pass through the resistor R1 to the load (RLoad). If the transient voltage raises to the anticipated voltage of 100 volts (in this example), the resistor, R1 and the load RLoad, will form a divider that is exactly equal to the desired output voltage. This is by design, having determined that R1/RLoad forms a divider that will divide 100 volts down to 33 volts. Once the transient ends, the voltage at the input will drop which will be detected by COMPARATOR1 and the “>32V” output will become inactive causing it to transition back to the NORMAL state. In this and all other states, the changes in output voltage are integrated by the output filter capacitors thereby minimizing ripple.

An examination of FIG. 2 and the following narrative provide further detail for this state of when a transient is detected. The switching devices are never operated in linear mode. Rather, the circuit detects the increase in voltage at the output of the first switching device and the source and turns the first switching device off by completely removing its controlling mechanism (for example, when a FET is used, the source-gate drive is disabled). The moment the output falls to a safe voltage, the first switching device's controlling mechanism is re-enabled. This pattern continues at a very high frequency such that the difference between the high voltage and low voltage is very small and easily filtered by an output capacitor whose value is determined by the fully saturated SW1 on resistance and the result is a DC level with low ripple output. The on/off mechanism of the first switching device is provided by the input comparator that senses the increase in input voltage as compared to a fixed reference voltage (i.e. the voltage threshold). This is a closed-loop, stable design that eliminates the high power and thermal runaway problems of the prior art and also eliminates the pulse width time constraints of high voltage spikes.

Another embodiment of the invention described in FIG. 2A illustrates an alternative configuration using MOSFETS as the switching devices and different locations for the comparators. The on/off mechanism of SW1 is provided by the input parameter that senses the increase in input voltage as compared to the voltage threshold. The output of the comparator is used to turn off SW1's controlling mechanism that through a voltage divider, supplies the comparator's input.

A review of FIG. 1 and the following narrative describes another state of the invention. If, while a transient is still present, RLOAD is less than the full load or at some point, changes to less than the full load, the drop through R1 will be less, resulting in a voltage higher than 33 volts at the output. This will immediately be recognized by COMPARATOR2 and its “>33V” output will become active. This will cause a transition to the DIVIDE R1/R2∥RLOAD state. SW2 will close, paralleling R2 and RLOAD. The result, by design, is that R1 and R2∥RLOAD, as a divider, will cause reduction in output voltage down to the desired range, in this example, below 33 volts. Once the output is below 33 volts, COMPARATOR2's “>33V” output will become inactive and SW2 will open and a transition back to the DIVIDE R1/RLOAD. This happens very fast and repeatedly which results in an accurate pulse width modulation of the added parallel R2 load. Note that both SW1 and SW2 are being operated in the saturated or “OFF” condition, not the linear condition, therefore little power is being dissipated in the FETs, or the alternative switching device. Again, the changes in output voltage are integrated by the output filter capacitors.

An examination of FIG. 2 and the following narrative provide further detail of this state where there is a voltage transient above the threshold at the comparator in front of the second switching device. The output of the comparator is used to turn on the second switching device's drive. The second switching device and R2 is operating in parallel with the actual load until the comparator's input determines that the voltage is equal to or lower than the threshold and then the second switching device's drive is removed. Once again, both the first switching device and the second switching device are being operated in the saturated or “OFF” condition, not the linear condition; therefore little power is being dissipated in the FETs, or the alternative switching device.

In an alternative embodiment described in FIG. 2A, the presence of a voltage above the threshold at the comparator in front of SW2 causes SW2's drive to turn on. SW2's drive, through a voltage divider, supplies the comparator's input. SW2 and R2 operate in parallel with the actual load until the comparator's input determines that the voltage is equal to or lower than the threshold and SW2's drive is removed.

Another possibility is that the transient fails to reach the anticipated voltage of 100 volts (a value required by MIL-STD-1275 testing). For that scenario, the output voltage will drop below 32 volts, restating that “R1” was selected based on the maximum transient of 100 volts and not less. Therefore with the voltage now below 32 volts this condition will be detected by COMPARATOR2 and its “<32V” output will become active. Transition to the NORMAL state will then take place which will cause SW1 to close and provide more voltage, drawn from the transient directly to RLOAD. The output voltage, sensed after the filter capacitor, will go up and when it reaches 32 volts, COMPARATOR2's “<32V” output will become inactive and cause a transition back to the DIVIDE R1/RLOAD state. This happens very fast and repeatedly which results in an accurate pulse width modification of SW1 to provide the desired output voltage after the filter capacitor.

It is typical in the art to use pulse width modulation (herein PWM) to drive the FET gate, using the FET as a constant current regulator to dissipate power to the source. This invention does not use PWM as it is typically used; instead there is an instant transition between the three previously described states as the voltage changes cross pre-set thresholds according to the state table previously described in Table 1. The invention does not implement a constant current regulator, but in fact as external load decreases, the invention adds a load resistor (R2) to increase current drawn from the transient pulse, and thereby “steers” unwanted energy to the load resistor (R2) and protects the load.

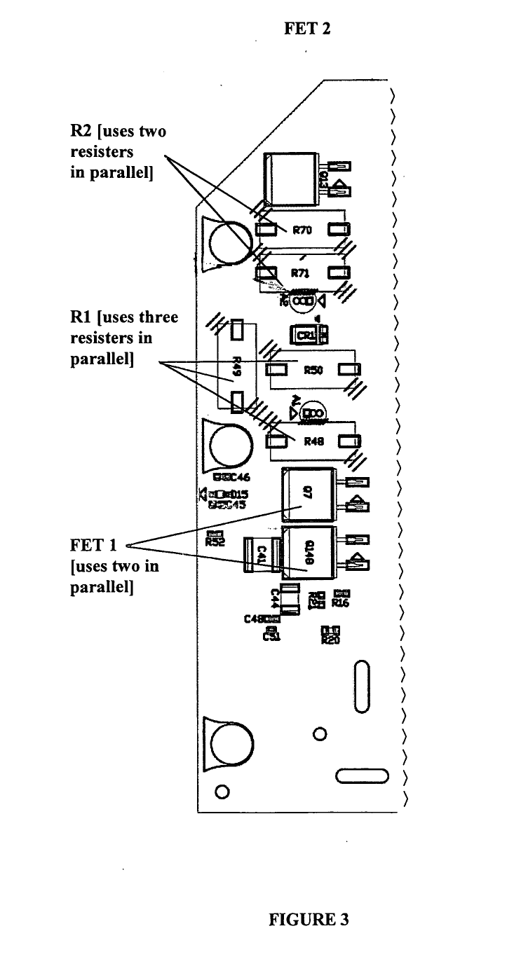

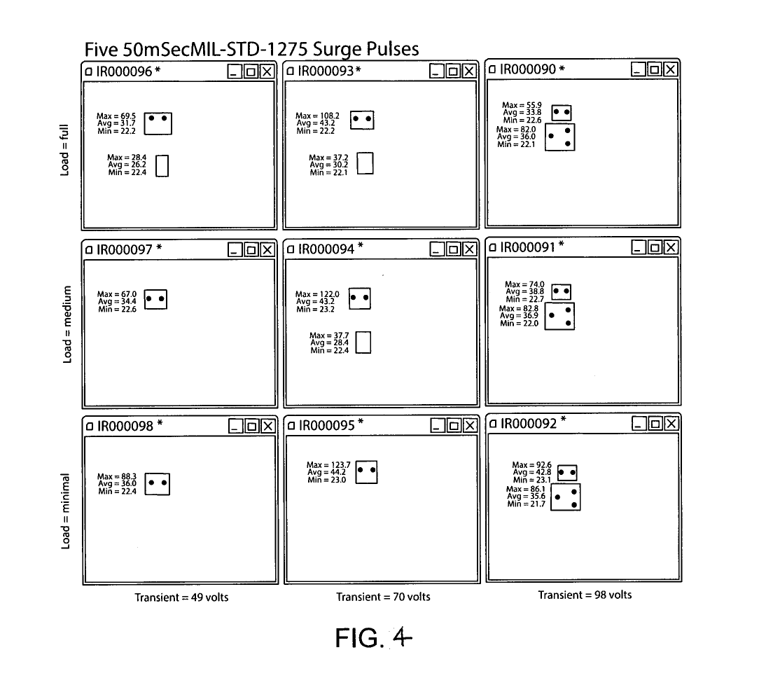

FIG. 3 describes the board layout for a preferred embodiment of the present invention. The scalability of the invention is illustrated when it is implemented using parallel resistors and parallel FETSs to optimize the circuit. The heating of the resistors, as they dynamically adjust to the level of the transient and variations in the load, can be observed in the images contained in FIG. 4. The temperatures of components R1, R2, FET1 and FET2 are shown and one can observe that the FETs do not even register a thermal change. The supporting thermal data contained in FIG. 4 verifies that when a transient is present, the FETs run cold (i.e. the FET is “OFF”), while the transient is dissipated in the resistors and/or sent to the load. The images in FIG. 4 represent a test of the worst case transient conditions required by the surge test in MIL-STD-1275. It can be observed in FIG. 4 that the resistor is well suited to dissipate the high power transients and remain well within their operational thermal boundaries. In the preferred embodiment the resistors are mounted against a heat sink which lowers their temperature even more hence this invention provides robustness.

The data compiled for the images in FIG. 4 were created using conditions per MIL-STD-1275, which creates transients or surges of 5 pulses, one second apart, at 50 milliseconds each. To comply with other applicable MIL standards and to account for a wide range of transients that can occur in industries where this invention would be used, the invention was tested throughout a range of possible transients in the range of the test. The three voltages described in the images of FIG. 4 are at the upper limit (98 volts), in the middle (70 volts), and just above the threshold that is considered a transient (40 volts). Three variations of load (light, medium and full) were used for each voltage transient value. The resistors can be observed heating consistently in accordance with the objectives of the invention for the three operational states previously described. Additionally, if there are excessive pulses, either of quantity or duration, the thermal protection is activated when the resistors reach a temperature limit of approximately 140° C., to enable a cool down period (in a preferred embodiment, the cool down period is approximately (6) seconds).

Thus, the verification of the thermal effects upon this invention as the circuitry makes the required adjustments thousands of times during each pulse conclusively validates the intent of the invention to eliminate thermal runaway to the FETs and integrated circuitry and to do so in a cost-effective and scalable manner.

The sensing devices can be implemented through a microcontroller programmed through High Definition Language (HDL) such as what was previously described in Table 1. The microcontroller generates electronic signals to the gate of the FETs, instructing the FETs (i.e. SW1 and SW2) to open or close. A feedback system is implemented so that the FET's output is returned to the microcontroller. The microcontroller compares the actual to desired output and generates a signal upon which an action is taken on the FETs. The microcontroller may also have additional features such as data communications, input/output lines, memory for storing different motion programs, and encoder feedback for closed loop positioning.

Although a voltage transient can take an indeterminate amount of time, the microcontroller has to work at higher speeds to make calculations and output updated commands. The time needed for these actions is called the sampling time. A microcontroller may use a single microprocessor to control motion on all axes. Alternatively, the microcontroller may use a distributed configuration where a central microprocessor coordinates dedicated special purpose motion control chips on each axis. Digital signal processors (DSPs) are special chips manufactured to address the increased speed requirements in calculating advanced control algorithms. When these operations are performed on an ordinary processor, they can consume too much time to provide high speed control. DSPs are often built using an architecture that allows instructions and data to move in parallel instead of sequentially. They often carry high speed hardware multipliers and fast on chip memories that eliminate many delays associated with information transfer to and from the chip.

The invention's implementation is adaptive to every transient situation. The invention has been designed to process any amplitude and any length pulse by adjusting R1 and R2. Additionally, because the adverse effects of excessive power have been eliminated, the usually short high voltage transient may be of very long duration and as such can be used with DC power sources as well as AC power sources that use a power adaptor that converts the AC to DC and then passes the current to the load. An example of such an application would be the invention's integration into a laptop power brick. In this application, the invention would become an encapsulated part that inserts between the power brick's output and the wires leading to the laptop (or other power operated device). The invention could also be placed in combination with a typical EMI common mode “bead” that is placed near the powered device's power input jack. In this configuration, the invention would also filter surges induced into the wire from the power “brick” to the devices input power connector.

Generally, the devices that run on DC power through a power adaptor and are used in normal household use are becoming more vulnerable to damage caused by transients. Users often plug devices such as laptops, flat screen televisions, and smart communication devices into the same circuits where legacy household appliances such as toasters and microwaves are used, and transients will often get past the AC/DC conversion circuitry. Also, transients in household circuitry also occur after a power outage. This invention's integration into the power adaptor devices should be of commercial benefit since the invention will minimize thermal runaway such that the components in the path of the transient will last longer. Since any device that utilizes transistors relies on direct current, and as legacy household devices evolve into “smart” appliances the need for the present invention will continue to expand.

Additionally, the present invention can be integrated into the circuitry that is used to provide DC power to militarized platforms. While the military is a major consumer of DC power, there is a growing trend commercially to distribute DC power directly to DC devices. The expansion of electric vehicles creates a need for substantial DC power sources to charge the vehicles. Many of the vehicle chargers under development utilize solar power. The unpredictability of solar technology is expected to produce transients. The present invention can be integrated between the solar powered charger and the vehicle circuitry to minimize thermal runaway and lessen potential damage to the vehicle circuitry during a transient.

Another driver for DC power is the data centers used to power the Internet and telecommunications networks. Large computer farms presently consume 1.3 percent of electricity worldwide and overall consumption is growing rapidly. Some companies are installing large centralized AC to DC converters and distributing 380 volt DC power across their server farms. The present invention can scale to accommodate the large voltage requirements and expected transient occurrences.

Some commercial buildings are being designed to have DC lighting circuits. Standards are being developed that would utilize 24 volt ceiling circuits and run LED ceiling lights on DC lines. Transient occurrences can cause safety hazards and the unique approach of the present invention to minimize thermal runaway can be very useful when integrated into the design of these circuits.

In another embodiment of this invention, the circuit will operate without R1. However, the presence of R1 in a preferred embodiment greatly reduces the activity in SW1 and thereby minimizes the linear operation of SW1 caused by transient rise and transient fall. In another embodiment of this invention, the circuit will operate without R2. The embodiments where either R1 or R2 is omitted operate by chopping the output as it moves from state to state. In another embodiment of this invention both R1 and R2 is omitted through the use of voltage chopping and very high speed switching as the circuit changes from state to state.

However, a preferred embodiment using both R1 and R2 is the optimal way to implement the invention because it allows the switching to occur slightly slower and with wider hysteresis. The invention's preferred embodiment provides scalability and economies by not only limiting damage to the circuitry, but also reducing the necessity of ultra high speed sensing devices because of the wider hysteresis allowed by the invention.

Hence, what has been described is a novel transient protection filter that minimizes the danger of a thermal runaway condition that can damage circuitry when transient voltages are present. The application and embodiments described herein is given as an example of the useful nature of the invention and is not intended to limit the scope of the invention. The present invention is equally beneficial in other circuit applications wherein there is a need to minimize the effects of thermal runaway on circuits and their components.

In one preferred embodiment metal oxide semiconductor field effect transistors may be used (herein “MOSFET”), although the invention can be practiced using other devices such as power transistors which can function as a unipolar transistor using pulse width modification herein “PWM”). The invention can also be practiced using relays as the switching devices. An embodiment using relays can be cost effective in applications that do not require high speed switching. Since the invention operates the switching device as “ON” or “OFF” and never with a voltage drop over the switching device when the transient is present, the functionality of the invention is maintained when a relay is used. The invention can enable an optimal relay performance with PWM as the thermal effects on the relay coil is minimal because the heat from the transient's dissipated power is spread to the resistors and the higher current is carried across the resistors. The use of relays as the switching devices can enable the invention to process an AC power source to the load. However, when the power source is DC and if faster switching, or electromagnetic interference is a concern, the invention may also be implemented using power MOSFETs of low gate drive power, faster switching speed and superior paralleling capability. Driving Power MOSFETs PWM requires very low impedance drivers to charge and discharge rapidly in order to keep unwanted power dissipation to a minimum.

We claim:

1. An improved transient protection filter comprising a switching circuit having a source terminal and a destination terminal wherein the switching circuit comprises:
one or more switching devices configured in series with a power source and load;
one or more capacitors coupled to the load side of the switching device;
a first means for sensing a predetermined threshold of a transient voltage applied at the source terminal of the switching device and having the ability to completely disrupt the energy of the transient voltage when said predetermined threshold is met.

2. The transient protection filter according to claim 1 further comprising a first resistor and a second resistor, said first resistor connected in parallel to said first switching device, said second resistor connected in parallel with said load.

3. The transient protection filter according to claim 2 wherein there is a second switching device.

4. The transient protection filter according to claim 3 wherein said first switching device and said second switching device are connected in series with said power source and said load and said first resistor is connected in parallel to said first switching device and said second resistor is connected in series to second switching device and said second resistor is connected in parallel to said load.

5. The transient protection filter according to claim 4 wherein said first means for sensing further comprises:
a first comparator connected between the source terminal and said parallel configured first switching device and said first resistor

6. The transient protection filter according to claim 5 wherein said first means for sensing further comprises:
a second comparator connected between said second switching device and said parallel configured said second resistor and said load.

7. The transient protection filter according to claim 4 wherein said switching devices are transistors.

8. The transient protection filter according to claim 7 wherein said transistor is a FET

9. The transient protection filter according to claim 4 wherein said switching devices are relays.

10. The transient protection filter according to claim 4 wherein said switching devices are switches.

11. The transient protection filter according to claim 6 wherein said first means for sensing senses that the voltage applied at the source terminal is below or equal to the predetermined threshold and a signal is sent to the controlling mechanism of said first switching device to be closed and a signal is sent to the controlling mechanism of said second switching device to be open providing a conductive path from said source terminal through said first switching device and said second resistor to said load.

12. The transient protection filter according to claim 6 wherein said first means for sensing senses that the voltage applied at the source terminal is below or equal to the predetermined threshold and a signal is sent to the controlling mechanism of said first switching device to be opened and a signal is sent to the controlling mechanism of said second switching device to be closed providing a conductive path from said source terminal through said first resistor and said second resistor to said load.

13. The transient protection filter according to claim 6 wherein said first means for sensing senses that the voltage applied at the source terminal is greater than the predetermined threshold and a signal is sent to the controlling mechanism of said first switching device to be open providing a conductive path from said source terminal through said first switching device and said second resistor to said load.

14. The transient protection filter according to claim 6 wherein said first means for sensing senses that the voltage applied at the source terminal is greater than the predetermined threshold and a signal is sent to the controlling mechanism of said second switching device to said load.

15. The transient protection filter according to claim 6 wherein the value of said first resistor and said load are configured to form a divider that is equal to the predetermined threshold.

16. The transient protection filter according to claim 6 wherein said first means for sensing senses that the voltage entering said second comparator is below the predetermined threshold and a signal is sent to the controlling mechanism of said first switching device to be closed providing a conductive path from said source terminal through said first switching device and said second resistor to said load.

17. The transient protection filter according to claim 6 wherein said first means for sensing senses that the voltage entering said second comparator is above the predetermined threshold and a signal is sent to the controlling mechanism of said second switching device to be closed providing a conductive path from said source terminal through said first resistor, said second resistor to said load.

18. The transient protection filter of claim 6 wherein the value of said first resistor, said second resistor and said load are configured to form a divider that is equal to the predetermined threshold.

19. The transient protection filter of claim 6 wherein said first means for sensing senses that the voltage entering said second comparator is below the predetermined threshold and signal is sent to controlling mechanism of said second switching device to be open providing a conductive path from said source terminal through said first switching device and said second resistor to said load.

20. The transient protection filter according to claim 1 wherein first means for sensing is implemented using a microcontroller.

21. The transient protection filter according to claim 4 wherein a self resetting thermostat is connected between the source terminal and the load.

22. The transient protection filter according to claim 1 wherein the source terminal is connected to a DC power supply.

23. The transient protection filter of claim 1 wherein the source terminal is connected to an AC power adaptor.

24. The transient protection filter according to claim 1 further comprising a resistor connected in parallel to said first switching device and in series with said load.

25. The transient protection filter according to claim 1 further comprising a resistor connected is series to said first switching device and in parallel with said load.

26. The transient protection filter according to claim 8 wherein said first means of sensing senses that the voltage applied at the source terminal is greater than the predetermined threshold at said first comparator but less than a maximum predetermined test value.

27. The transient protection filter according to claim 8 wherein said first means for sensing senses that the voltage entering said second comparator is equal to or above the predetermined threshold wherein the value of said first resistor and said load are configured to form a divider that is greater than the predetermined threshold.

28. The transient protection filter according to claim 8 wherein said first means for sensing senses that the voltage entering said second comparator is below the predetermined threshold and a signal is sent to said gate of said FET to be closed providing a conductive path from said source terminal through said first FET and said second resistor to said load.

29. The transient protection filter according to claim 8 wherein said first means for sensing senses that the voltage entering said second comparator is equal to or above the predetermined threshold wherein the value of said first resistor and said load are configured to form a divider that is equal to the predetermined threshold.

30. The transient protection filter according to claim 8 wherein said first means senses that the voltage entering said second comparator is below the predetermined threshold and signal is sent to gate of said second FET to be open providing a conductive path from said source terminal through said first FET and said second resistor to said load.

31. The transient protection filter according to claim 8 wherein said FET gate is driven using pulse width modification.

32. The transient protection filter according to claim 8 wherein said pulse width modification causes said FET gate to instantly transition between “ON” and “OFF”.

33. The transient protection filter according to claim 8 wherein said self resetting thermostat senses that one or more said resistors have reached a pre-determined temperature threshold wherein said switching circuit will temporarily suspend for a cooling down period.

34. The transient protection filter according to claim 8 wherein the transient voltage exceeds 100 volts.

35. The transient protection filter according to claim 8 wherein the length of transient occurrence exceeds 50 milliseconds.

36. An improved switching circuit having transient protection, said circuit comprising
a source terminal and a destination terminal;
one or more pairs of power transistors configured in series, each pair comprising a first power transistor and a second power transistor, each of said power transistors having a gate, a drain and a source, said source being coupled to said source terminal of the switching circuit, said gate being responsive to a control signal, said power transistor coupled to provide a unidirectional path from said source to said drain, said drain coupled to a load;
one or more pairs of resistors, each pair of resistors comprising a first resistor and a second resistor, said first resistor configured in parallel to said first power transistor, said first resistor coupled to said terminal and to said second resistor, said second resistor configured in series to said first resistor and said power transistor pair, said second resistor configured in parallel to said load;
one or more capacitors coupled to the second power transistor, the second resistor, and the drain;
a first means for sensing a predetermined threshold of a transient voltage applied at the source terminal of the switching circuit and rerouting the energy of the transient voltage in response thereto.

37. A method of protecting a circuit from transients comprising
providing a switching circuit having a source terminal and a destination terminal said switching circuit comprising:
one or more pairs of power transistors configured in series, each pair consisting of a first power transistor and a second power transistor, each of said power transistor having a gate, a drain and a source, said source being coupled to said source terminal of the switching circuit, said gate being responsive to a control signal, said power transistor coupled to provide a unidirectional path from said source to said drain, said drain coupled to a load;
one or more pairs of resistors, each pair consisting of a first resistor and a second resistor, said first resistor configured in parallel to said first power transistor, said first resistor coupled to said terminal and to said second resistor, said second resistor configured in series to said first resistor and said power transistor pair, said second resistor configured in parallel to said load;
one or more capacitors coupled to the second power transistor, the second resistor, and the drain;
sensing a transient voltage applied at the source terminal of the switching circuit such that when the voltage applied at the source terminal is below or equal to the predetermined threshold sending a signal to said gate of said first power transistor causing said gate to be closed and sending a signal to said gate of said second power transistor to be open; and
providing a conductive path from said source terminal through said first power transistor and said second resistor to said load.

38. A method of protecting a circuit from transients comprising
providing a switching circuit having a source terminal and a destination terminal said switching circuit comprising:
one or more pairs of power transistors configured in series, each pair consisting of a first power transistor and a second power transistor, each of said power transistor having a gate, a drain and a source, said source being coupled to said source terminal of the switching circuit, said gate being responsive to a control signal, said power transistor coupled to provide a unidirectional path from said source to said drain, said drain coupled to a load;
one or more pairs of resistors, each pair consisting of a first resistor and a second resistor, said first resistor configured in parallel to said first power transistor, said first resistor coupled to said terminal and to said second resistor, said second resistor configured in series to said first resistor and said first power transistor pair, said second resistor configured in parallel to said load;
a first comparator connected between the source terminal and said parallel configured first power transistor and said first resistor;
a second comparator connected between the said second power transistor and said second resistor configured parallel to said load;
one or more capacitors coupled to the second power transistor, the second resistor, and the drain;
sensing the voltage applied at the source terminal such that when said voltage is greater than a predetermined threshold at a first comparator a signal is sent to said gate of said first power transistor causing said gate to open and
providing a conductive path from said source terminal through said first resistor and said second resistor to said load.

39. The method according to claim 37 wherein the value of said first resistor and said load are configured to form a divider that is equal to the predetermined threshold.

40. The method according to claim 38 wherein when the voltage entering said second comparator is below the predetermined threshold a signal is sent to said gate of said first power transistor to be closed and providing a conductive path from said source terminal through said first power transistor and said second resistor to said load.

41. The method according to claim 38 wherein when the voltage entering said second comparator is above the predetermined threshold a signal is sent to gate of said second power transistor to be closed; and
providing a conductive path from said source terminal through said first resistor, said second resistor, and said second power transistor configured in parallel to said to said load.

42. The method according to claim 38 wherein when the voltage entering said second comparator is below the predetermined threshold a signal is sent to said gate of said second power transistor to be open; providing a conductive path from said source terminal through said first power transistor and said second first to said load.
